(19) United States
(12) Patent Application Publication
(10) Pub. No.: US 2009/0319810 A1
(43) Pub. Date: Dec. 24, 2009

(54) RECEIVING APPARATUS AND ACTIVATION CONTROL METHOD FOR RECEIVING APPARATUS

(75) Inventor: Yasuhiro Aoyama, Tokyo (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, OSAKA (JP)

(21) Appl. No.: 12/307,485

(22) PCT Filed: Jan. 11, 2007
(86) PCT No.: PCT/JP2007/050244

§ 371 Date: Jan. 5, 2009

(51) Int. Cl. G06F 13/24; G06F 1/26

(52) U.S. Cl. 713/300; 710/261

(57) ABSTRACT

A receiving apparatus does not frequently activate a host processor in a sleep mode, so that it is possible to reduce a time overhead when the host processor transitions from a sleep mode to a running mode, also suppress power consumed in the overhead time and improve communication performance. With this apparatus, a communication interface circuit (101) extracts packet data from a signal received from a network. A communication interface control circuit (102) decides whether or not packet data is packet data that must be received, and, when the packet data is packet data that must be received, issues an interrupt signal. A power supply circuit (106) supplies power. When receiving the interrupt signal, the host processor (107) executes a program including reception processing.

### TECHNICAL FIELD

The present invention relates to a receiving apparatus and an activation control method for the receiving apparatus. More particularly, the present invention relates to a receiving apparatus and an activation control method for the receiving apparatus which minimize power consumption by narrowing power supply locations.

### BACKGROUND ART

In terminal apparatuses such as mobile telephones used for communication in an IP network system, a current consumed by the operation of receiving broadcast packets and multicast packets which do not require reception processing, has a great influence upon a battery duration. Therefore, when there is no processing to be done, the terminal apparatus stops the host processor when possible, thereby reducing power consumption.

For example, in communication using a non-dedicated line, broadcast packets such as an ARP packet, uPnP packet and NetBIOS packet are received even by irrelevant terminals. Broadcast packets also include ones that must be received by the terminal apparatus, the terminal apparatus needs to process all received packets through the host processor once and decide whether each packet must be subjected to reception processing or discarded. If the frequency of receiving packets unnecessary to be received is very low compared to the frequency of receiving packets that must be received, there is no problem, but there are cases in an actual communication path where more packets unnecessary to be received are received than packets that must be received, and it is not uncommon that several packets unnecessary to be received are received every second.

FIG. 1 shows an overview of an operation sequence of a conventional terminal apparatus. For ease of explanation, FIG. 1 shows the relationship of event occurrences between communication interface circuit 10 and host processor 11. In response to a timing at which communication interface circuit 10 receives radio communication packet 12, interrupt signal 13 is sent to host processor 11 and host processor 11 which has been in a sleep mode (Sleep) 14 is set a running mode (Run) 15 every time.

After host processor 11 transitions from sleep mode 14 to running mode 15 and is thereby supplied with power and a clock, host processor 11 stays in an operation-disabled mode (Ready) for a while as power and clock stabilization waiting time 16. After stabilization waiting time 16 passes and the power and clock stabilize, host processor 11 performs desired packet reception processing, communication protocol processing and application processing in packet reception processing period 17 and performs post-processing (Close) to transition from running mode 15 to sleep mode 14 again in subsequent post-processing period 18.

Next, the operation of the conventional terminal apparatus will be explained in further detail using FIG. 2. FIG. 2 shows an overview of an operation sequence of the conventional terminal apparatus.

While the terminal apparatus is in a sleep mode, interface function section 50 receives packet data from a network (ST60) and interface function section 50 which has received the packet data issues an interrupt signal to activate the terminal apparatus (ST61). The interrupt signal is transferred to interrupt control section 52 through network interface control section 51 (ST62). Next, interrupt control section 52 issues a control signal to power control and clock generation section 53 (ST63) and power control and clock generation section 53 supplies power and a clock to host processor 54 (ST64). Host processor 54, which has been supplied with the power and clock, transitions from sleep mode 70 to running mode 71 and switches access to interface function section 50 (ST65 and ST66).

Furthermore, conventionally, a technique of improving communication efficiency by changing a method of responding to an interrupt from a network interface upon establishment of the link and after establishment of the link, is known (e.g., Patent Document 1). Patent Document 1 discloses operating the system by an interrupt from the network interface upon establishment of the link, and performing desired packet reception processing by stopping the interrupt from the network interface after establishment of the link and periodically monitoring whether received data is stored in a reception buffer through a timer interrupt. According to Patent Document 1, without using any hardware interrupt after establishment of the link, it is possible to reduce an overhead of an interrupt that occurs in the processor and improve communication performance.

### Patent Document 1: Japanese Patent Application Laid-Open No. 2003-244273

### DISCLOSURE OF INVENTION

### Problems to be Solved by the Invention

However, in the conventional apparatus, stabilization waiting time 16 includes not only a time to wait for stabilization of power and a clock but also a time to reset various kinds of context information for host processor 11 to restart an operation even after the power and clock stabilize, and requires a time equivalent to or greater than packet reception processing period 17. Thus, the conventional apparatus has a problem that there is a large time overhead when host processor 11 transitions from a sleep mode to a running mode. Furthermore, stabilization waiting time 16 is a period after the power and clock are already supplied, stabilization waiting time 16 is regarded as an overhead time from the standpoint of reducing power consumption and there is a problem that power is consumed during this overhead time. The above problem becomes significant especially in a situation where several packets not requiring reception processing are received every second. Furthermore, Patent Document 1 also has a problem that, although an overhead resulting from an interrupt that occurs upon the running mode can be reduced, an overhead when the host processor transitions from a sleep mode to a running mode cannot be reduced.

It is therefore an object of the present invention to provide a receiving apparatus and an activation control method for the receiving apparatus that do not frequently activate a host processor in a sleep mode, thereby reducing a time overhead when the host processor transitions from a sleep mode to a running mode, suppressing power consumed in the overhead time and improving communication performance.

### Means for Solving the Problem

The receiving apparatus of the present invention adopts a configuration including: a packet data extraction section that extracts packet data from a received signal; an interrupt signal generation section that generates an interrupt signal for requesting reception processing of the extracted packet data; a reception processing execution section that executes the reception processing by transitioning from a sleep mode to a running mode based on the generated interrupt signal; and a timing control section that provides a predetermined time difference between a timing for generating the interrupt signal in the interrupt signal generation section and a timing of the transition.

The activation control method for the receiving apparatus of the present invention includes the steps of: extracting packet data from a received signal; generating an interrupt signal for requesting reception processing of the extracted packet data; executing the reception processing by, in the receiving apparatus, transitioning from a sleep mode to a running mode based on the generated interrupt signal; and providing a predetermined time difference between a timing for generating the interrupt signal and a timing of the transition.

### ADVANTAGEOUS EFFECT OF THE INVENTION

The present invention does not frequently activate a host processor in a sleep mode, so that it is possible to reduce a time overhead when the host processor transitions from a sleep mode to a running mode, suppress power consumed in the overhead time and improve communication performance.

### BRIEF DESCRIPTION OF DRAWINGS

FIG. 1 shows an overview of an operation sequence of a conventional terminal apparatus;

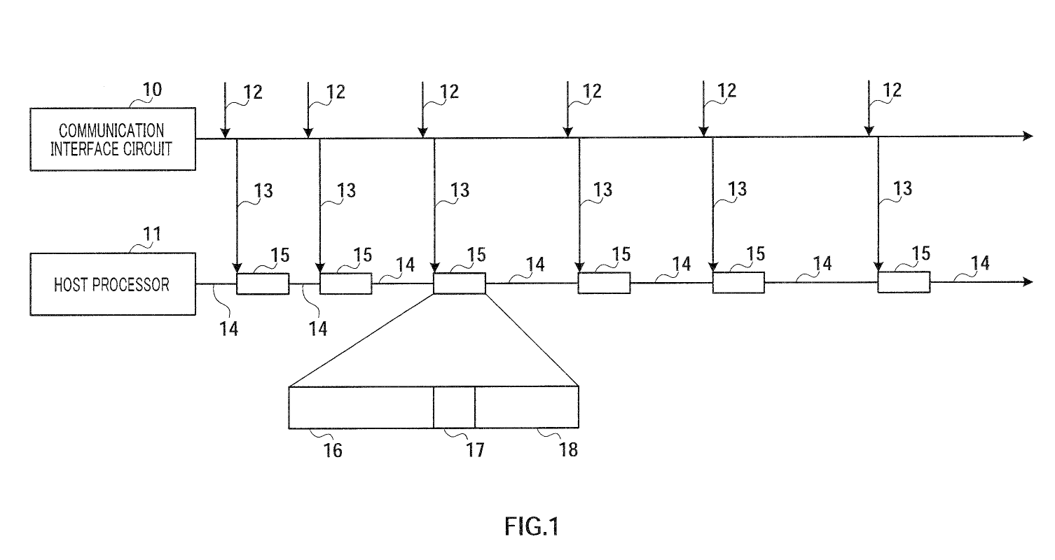

FIG. 2 shows an overview of an operation sequence of the conventional terminal apparatus;

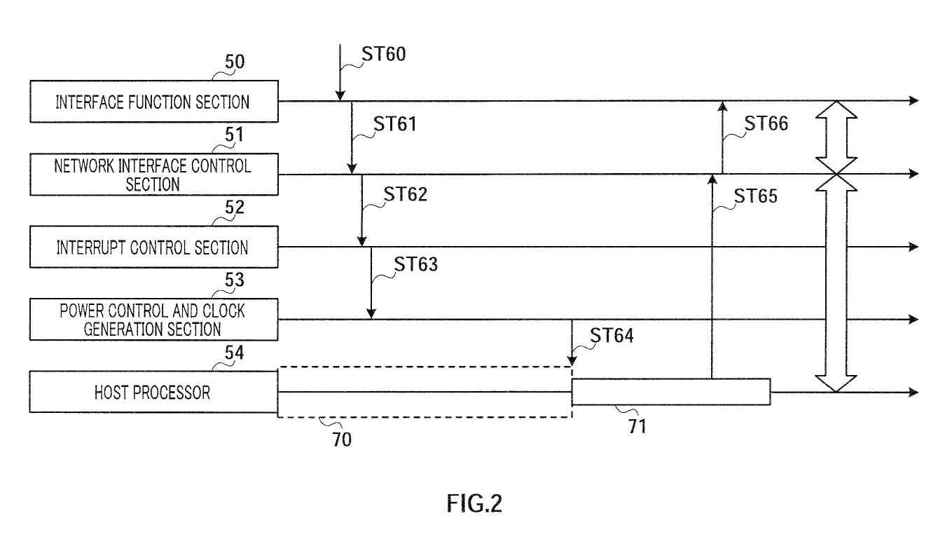

FIG. 3 is a block diagram showing a configuration of a receiving apparatus according to an embodiment of the present invention;

FIG. 4 is a block diagram showing a configuration of an interrupt delay circuit according to the embodiment of the present invention;

FIG. 5 shows an operation timing of the receiving apparatus according to the embodiment of the present invention;

FIG. 6 shows an operation timing of the interrupt delay circuit according to the embodiment of the present invention;

FIG. 7 shows a control sequence of the receiving apparatus according to the embodiment of the present invention; and

FIG. 8 shows a relationship between the number of times the host processor is activated and an interrupt delay setting time in a WFI mode for each frequency of arrival of an unnecessary packet according to the embodiment of the present invention.

### BEST MODE FOR CARRYING OUT THE INVENTION

Now, an embodiment of the present invention will be described in detail with reference to the accompanying drawings.

### Embodiment

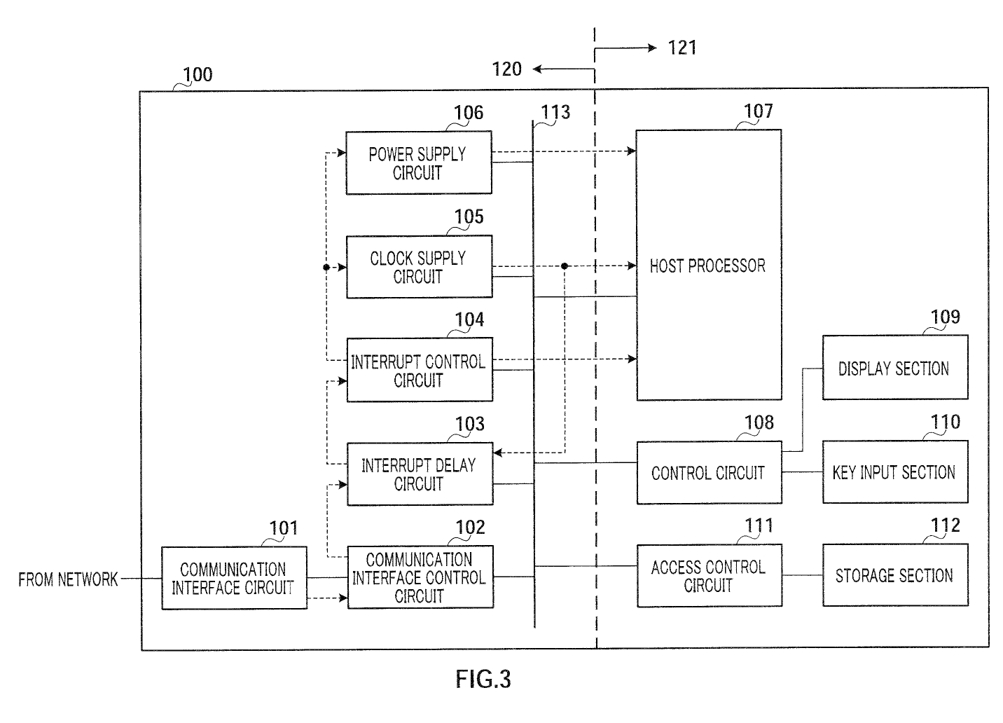

FIG. 3 is a block diagram showing a configuration of receiving apparatus 100 according to the embodiment of the present invention. In receiving apparatus 100, power and an operation clock are supplied all the time to communication interface circuit 101, communication interface control circuit 102, interrupt delay circuit 103, interrupt control circuit 104, clock supply circuit 105 and power supply circuit 106 arranged in power supply area (constant running area) 120. Furthermore, power and an operation clock are supplied depending on a situation, to host processor 107, control circuit 108, display section 109, key input section 110, access control circuit 111 and storage section 112 arranged in power supply area (selectively running area) 121.

Communication interface circuit 101, which is a packet data extraction means, realizes physical layer control over a communication function and performs layer 1 processing on a radio wave inputted from a network based on the control of communication interface control circuit 102. More specifically, communication interface circuit 101 performs processing of extracting packet data from the signal received from the network and outputs the extracted packet data to communication interface control circuit 102.

Communication interface control circuit 102, which is an interrupt signal generation means, controls communication interface circuit 101 and also realizes link layer control over a communication function. More specifically, communication interface control circuit 102 decides whether or not the packet data inputted from communication interface circuit 101 is packet data that must be received. Whether or not the packet data is packet data that must be received in this case is decided by mainly deciding a destination address of a link layer (layer 2). For example, when the packet data is a unicast packet and the destination address shows a physical address of the receiving apparatus or when the destination address shows that the packet data is a broadcast/multicast packet, communication interface control circuit 102 decides that the packet data is packet data that must be received. Communication interface control circuit 102 discards the packet data when deciding that the packet data is not packet data that must be received, and, when deciding that the packet data is packet data that must be received, outputs an interrupt signal to interrupt delay circuit 103 to request host processor 107 to perform reception processing on the packet data.

Interrupt delay circuit 103, which is a timing control means, gives a certain amount of delay to the interrupt signal inputted from communication interface control circuit 102 and outputs the delayed interrupt signal to interrupt control circuit 104. Details of the configuration of interrupt delay circuit 103 will be described later.

Interrupt control circuit 104 collects a group of interrupt signals which include the interrupt signal inputted from interrupt delay circuit 103 and which are issued when information is transmitted from a peripheral device to host processor 107, performs, for example, adjustment of priority and outputs the interrupt signal to host processor 107. Furthermore, when an interrupt to host processor 107 occurs, interrupt control circuit 104 outputs a host activation report to clock supply circuit 105 and power supply circuit 106.

Clock supply circuit 105 supplies an operation clock to power supply area 120 and power supply area 121. More specifically, clock supply section 105 supplies a clock all the time to communication interface circuit 101, communication interface control circuit 102, interrupt delay circuit 103, interrupt control circuit 104 and power supply circuit 106 arranged in power supply area 120, and, when receiving a host activation report from interrupt control circuit 104, starts supplying a clock to host processor 107, control circuit 108, access control circuit 111 and storage section 112 arranged in power supply area 121.

Power supply circuit 106 supplies power to power supply area 120 and power supply area 121. More specifically, power supply section 106 supplies power all the time to communication interface circuit 101, communication interface control circuit 102, interrupt delay circuit 103, interrupt control circuit 104 and power supply circuit 106 arranged in power supply area 120, and, when receiving a host activation report from interrupt control circuit 104, also starts supplying power to host processor 107, control circuit 108, access control circuit 111 and storage section 112 arranged in power supply area 121.

Host processor 107, which is a reception processing execution means, executes a program including packet data transmission/reception processing through communication interface circuit 101. More specifically, when receiving a power supply from power supply circuit 106, host processor 107 transitions from a sleep mode to a running mode and receives a clock supply from clock supply circuit 105. Furthermore, after transitioning from the sleep mode to the running mode, if an interrupt signal is received from interrupt control circuit 104, host processor 107 queries interrupt control circuit 104 about an interrupt source through data bus 113. When recognizing through the query that the interrupt is from communication interface control circuit 102, host processor 107 switches access to communication interface control circuit 102, recognizes the existence of packet data that must be received, transfers the received packet data to storage section 112 and performs communication protocol processing on layer 3 or higher layers.

When receiving a clock supply from clock supply circuit 105 and a power supply from power supply circuit 106, control circuit 108 controls the screen display of display section 109 and also controls key input of key input section 110.

Display section 109 displays a screen under the control of control circuit 108.

Key input section 110 receives key input under the control of control circuit 108.

Access control circuit 111 performs access control on storage section 112.

Storage section 112 is a memory for data storage used to temporarily save packet data when host processor 107 is operated, a screen is displayed on display section 109 or data is transmitted/received, and packet data is written into or read from storage section 112 according to the access control by access control circuit 111.

Power and a clock are supplied all the time to communication interface circuit 101, communication interface control circuit 102, interrupt delay circuit 103, interrupt control circuit 104, clock supply circuit 105 and power supply circuit 106 arranged in power supply area (constant running area) 120 from power supply circuit 106 and clock supply circuit 105 regardless of the operation mode and the communication state of receiving apparatus 100, and communication interface processing and the like can be performed at any time. Therefore, even when host processor 107 is in a sleep mode, communication interface control circuit 102 can issue an interrupt signal when communication interface control circuit 102 must decide the received packet data and execute reception processing.

On the other hand, when host processor 107 is in a sleep mode, supplies of both power and clock to host processor 107, control circuit 108, display section 109, key input section 110, access control circuit 111 and storage section 112 arranged in power supply area (selectively running area) 121 are shut off by the operations of power supply circuit 106 and clock supply circuit 105, and autonomous operation is not possible.

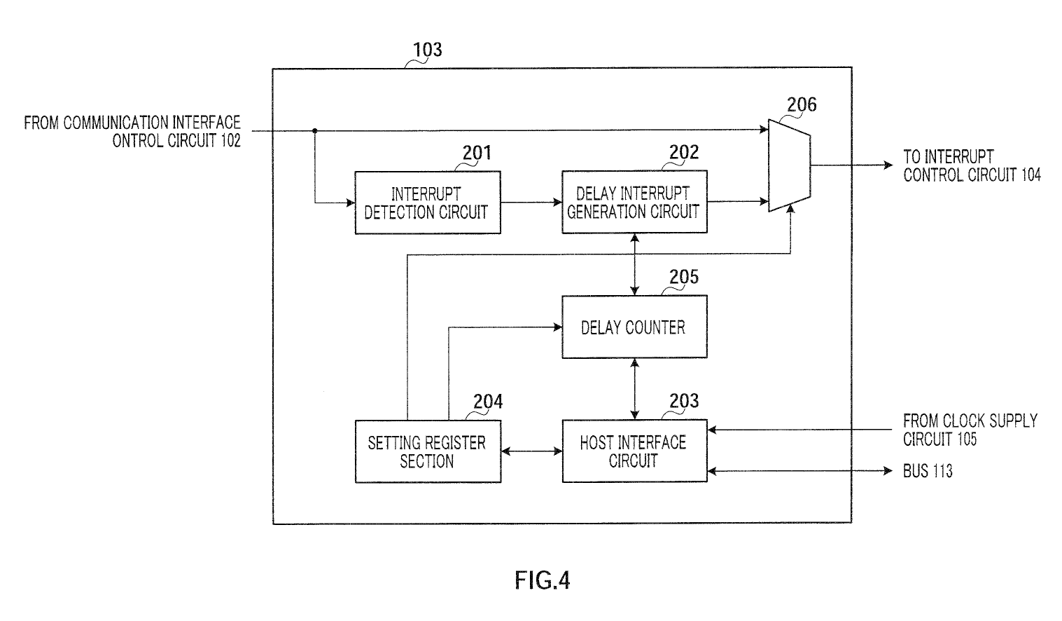

Next, a detailed configuration of interrupt delay circuit 103 will be explained using FIG. 4. FIG. 4 is a block diagram showing a configuration of interrupt delay circuit 103.

Interrupt detection circuit 201 detects an occurrence of an interrupt, and, when detecting an interrupt signal inputted from communication interface control circuit 102, activates delay interrupt generation circuit 202. Furthermore, to remove hazard (prevention of noise reaction) for an input signal, interrupt detection circuit 201 is also provided with a protection mechanism for three clock cycles and detects an occurrence of an interrupt. That is, when detecting that the logic of the interrupt signal has turned to the negative polarity for three consecutive clock cycles, interrupt detection circuit 201 learns that an interrupt has occurred. The interrupt signal shows an occurrence of an interrupt according to the logic of the negative polarity.

Delay interrupt generation circuit 202 operates in conjunction with delay counter 205. More specifically, delay interrupt generation circuit 202 is activated when interrupt detection circuit 201 detects an interrupt, and starts a count-up operation of delay counter 205. When a counter value of delay counter 205 reaches a full count, delay interrupt generation circuit 202 outputs a delay interrupt signal to asynchronous selector 206.

Host interface circuit 203 accepts setting of the operation mode from host processor 107 through bus 113. More specifically, host interface circuit 203 functions as an end point of bus control, writes the set value received from host processor 107 to setting register section 204 in synchronization with the clock supplied from clock supply circuit 105 and enables the contents of setting register section 204 to be referred from host processor 107. Furthermore, host interface circuit 203 reads the counter value of delay counter 205 at the request from host processor 107 and outputs the counter value to host processor 107.

Setting register section 204 stores the set value received from host interface circuit 203 and stores a disable/enable set value of interrupt delay circuit 103 and a full counter value for setting the amount of delay, which are the setting items from host processor 107. The full counter value received from host interface circuit 203 can be set to an arbitrary value by host processor 107. Setting register section 204 outputs the stored disable/enable set value to asynchronous selector 206 and reports the stored full counter value to delay counter 205 to determine a stop timing (amount of delay until stop) of delay counter 205.

Delay counter 205 operates in conjunction with delay interrupt generation circuit 202. More specifically, when receiving a report of a count-up start timing from delay interrupt generation circuit 202, delay counter 205 updates the counter value for every clock. At the time the counter value reaches the full counter value reported from setting register section 204, delay counter 205 stops the count-up operation and reports the timing at which the count-up operation is stopped, to delay interrupt generation circuit 202.

Asynchronous selector 206 is used to switch operation enable/disable of interrupt delay circuit 103 and selects a case where the interrupt signal inputted from communication interface control circuit 102 is directly outputted or a case where the delay interrupt signal inputted from delay interrupt generation circuit 202 is outputted. The case where asynchronous selector 206 directly outputs the interrupt signal inputted from communication interface control circuit 102 is equivalent to a case where interrupt delay circuit 103 does not function.

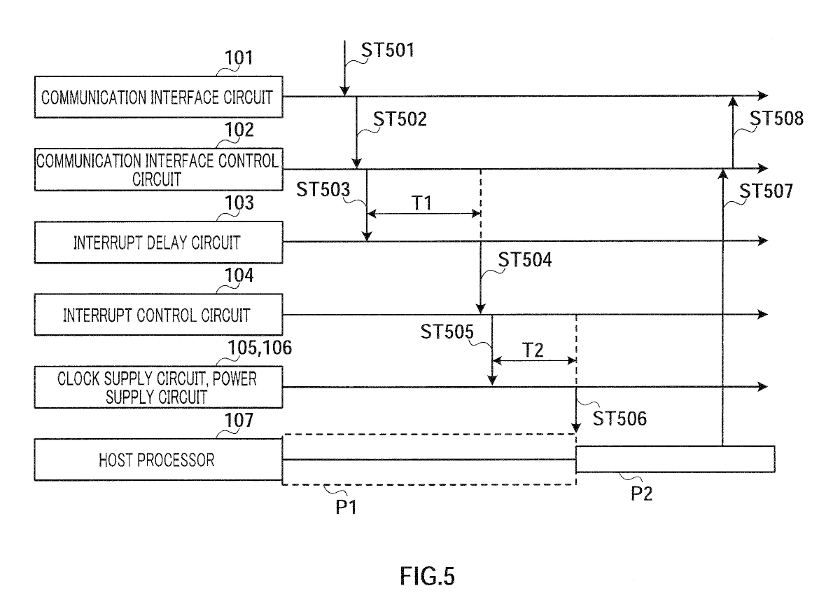

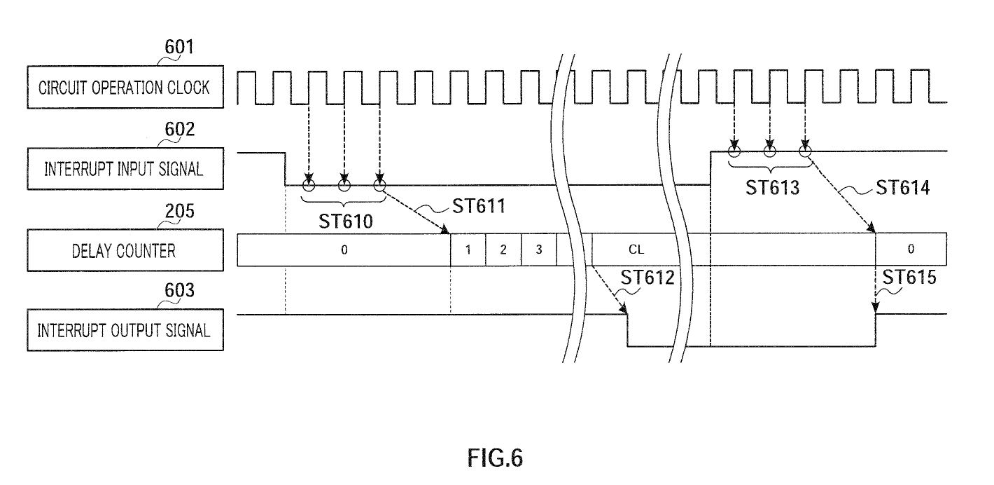

Next, the operation of receiving apparatus 100 will be explained using FIG. 5 and FIG. 6. FIG. 5 shows an operation timing of receiving apparatus 100 and FIG. 6 shows an operation timing of interrupt delay circuit 103.

When power supply area (selectively running area) 121 is in a sleep mode, communication interface circuit 101 receives packet data from the network (ST501) and issues an interrupt signal to activate power supply area (selectively running area) 121 including host processor 107 (ST502). When deciding that the packet data is packet data that must be received, communication interface control circuit 102 that has received the interrupt signal issues an interrupt signal to interrupt delay circuit 103 (ST503).

The operation of interrupt delay circuit 103 after ST503 will be explained using FIG. 6. When detecting a low level of interrupt input signal (IRQ_I) 602, interrupt detection circuit 201 detects assertion of the interrupt from communication interface circuit 101. In this case, as a measure for noise, when detection of the low level for three cycles of circuit operation clock (PCLK) 601 can be confirmed, interrupt detection circuit 201 detects assertion of the interrupt (ST610). The interrupt signal is a signal asynchronous to circuit operation clock 601.

After interrupt detection circuit 201 detects assertion of interrupt input signal 602, delay interrupt generation circuit 202 is activated, and activated delay interrupt generation circuit 202 causes delay counter 205 to start a count-up operation (ST611).

After the count-up operation starts, delay counter 205 stops the count-up at the time the counter value reaches full counter value CL (Counter Limit), and delay counter 205 has stopped the count-up, and so asynchronous selector 206 asserts interrupt output signal (IRQ_O) 603 to “low” (ST612).

Next, when detecting a high level of interrupt input signal 602, interrupt detection circuit 201 detects negation of the interrupt from communication interface circuit 101. In this case, as a measure for noise, when the detection of the high level for three cycles of circuit operation clock 601 can be confirmed, interrupt detection circuit 201 detects negation of the interrupt (ST613).

After interrupt detection circuit 201 detects negation of interrupt input signal 602, delay interrupt generation circuit 202 resets delay counter 205 (ST614), and asynchronous selector 206 negates interrupt output signal 603 to “high” (ST615).

Next, returning to FIG. 5, through the processing from ST610 to ST615, after delay time (Intentional Delay) T1 passes after the interrupt input signal is inputted (ST503), interrupt delay circuit 103 outputs an interrupt output signal to interrupt control circuit 104 (ST504).

Next, interrupt control circuit 104 issues a host activation report, which is a control signal, to clock supply circuit 105 and power supply circuit 106 (ST505) and causes clock supply circuit 105 and power supply circuit 106 to start generating power and a clock for the operation of host processor 107.

Next, clock supply circuit 105 and power supply circuit 106 start supplying the clock and power after activation wait time (Awake Overhead) T2 (ST506) passes.

By this means, host processor 107 transitions from sleep mode (Sleep Mode) P1 to running mode (Interrupt Handler) P2 and switches access to communication interface control circuit 102 (ST507 and ST508).

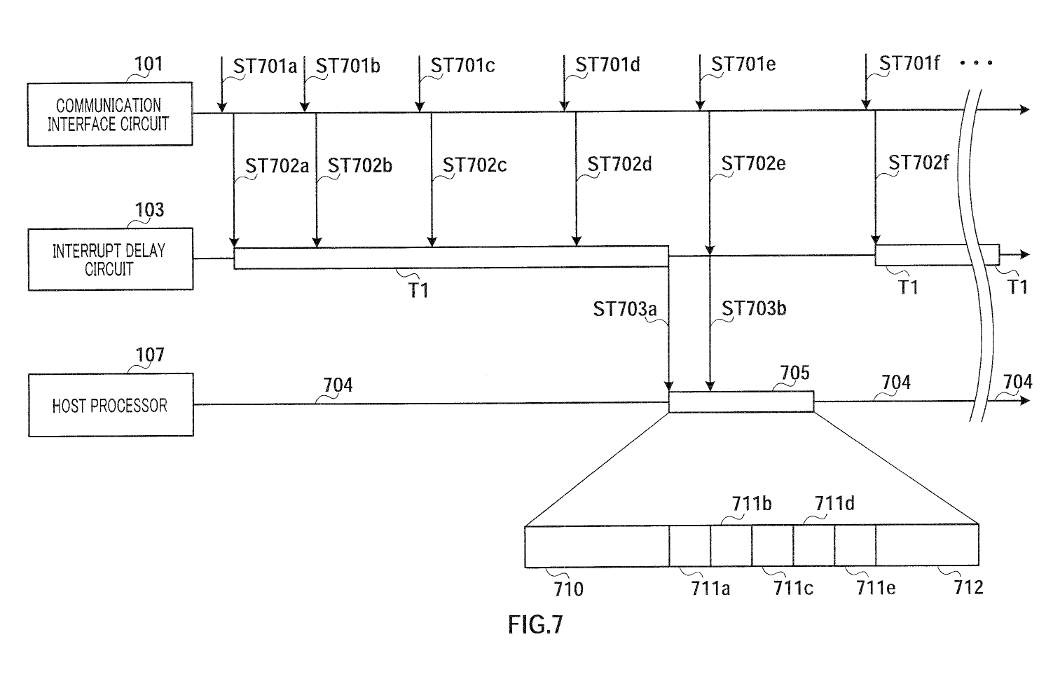

FIG. 7 shows a control sequence of receiving apparatus 100. For ease of explanation, FIG. 7 shows the relationship of event occurrences between communication interface circuit 101, interrupt delay circuit 103 and host processor 107.

Communication interface circuit 101 receives packet data from the network (ST701a, ST701b, . . . ) and sends interrupt signals to interrupt delay circuit 103 (ST702a, ST702b . . . ) in response to a timing at which communication interface circuit 101 receives packet data from the network. In this case, interrupt delay circuit 103 does not output any interrupt output signal in response to the interrupt input signals (ST702a to ST702d) within delay time T1. After delay time T1 passes, interrupt delay circuit 103 then outputs an interrupt output signal in response to the interrupt input signals (ST702a to ST702d) inputted within delay time T1 (ST703a). Furthermore, when an interrupt input signal is inputted after delay time T1 (ST702e) passes, interrupt delay circuit 103 outputs an interrupt output signal in response to the inputted interrupt input signal (ST703b).

After host processor 107 transitions from sleep mode 704 to running mode 705 and is thereby supplied with power and a clock, host processor 107 stays in an operation disabled mode for a while as power and clock stabilization waiting time 710. After stabilization waiting time 710 passes and the power and clock stabilize, host processor 107 performs desired packet reception processing, communication protocol processing and packet reception processing of application processing in packet reception processing periods 711a to 711e and performs post-processing to transition from running mode 705 to sleep mode 704 again in subsequent post-processing period 712.

In packet reception processing periods 711a to 711e, host processor 107 collectively performs reception processing on respective packet data which triggered input of the interrupt input signals (ST702a to ST702d) within delay time T1. In this way, receiving apparatus 100 can provide a time difference between the timing for generating the interrupt input signals (ST702a to ST702d) in communication interface control circuit 102 and the timing for host processor 107 to transition from sleep mode 704 to running mode 705.

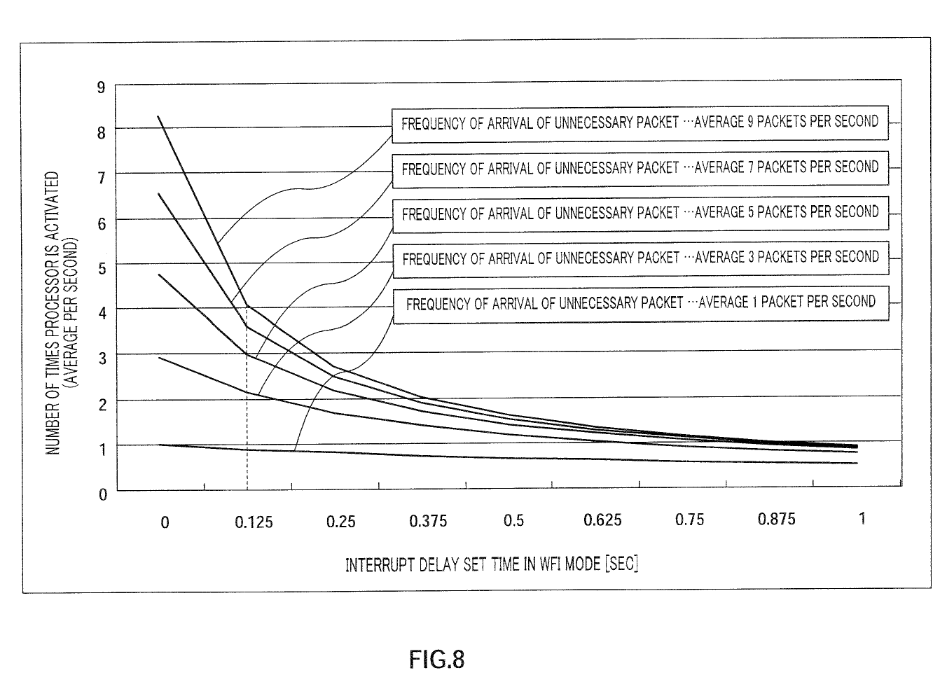

FIG. 8 shows the relationship between the number of times host processor 107 is activated and an interrupt delay set time in a WFI (Wait For Interrupt) mode for each frequency of arrival of an unnecessary packet. Here, the WFI refers to a mode in which the host processor stops its operation and waits until some interrupt is received.

As shown in FIG. 8, for example, even in an environment of significant noise where nine unnecessary packets are received for every second, it is possible to reduce the activation time of host processor 107 to half or less by setting the delay time 0.125 msec compared to a case where the delay time is set 0 msec.

The processor activation probability can be calculated by equation 1. However, equation 1 is an approximate equation of the processor activation probability, and a general tendency is as shown in FIG. 8.

Processor activation probability (average number of activations per second)=(p⁻¹+t)⁻¹ (Equation 1)

where p is a probability of arrival of an unnecessary packet (average frequency of arrival per second), and

t is the sum of overhead time required to activate host processor 107 (assumed to be 10 ms in FIG. 8) and interrupt delay set time.

As described above, according to the present embodiment, the host processor in a sleep mode is not frequently activated, so that it is possible to reduce a time overhead when the host processor transitions from a sleep mode to a running mode, reduce power consumed in the overhead time and improve communication performance.

### INDUSTRIAL APPLICABILITY

The receiving apparatus and the activation control method for the receiving apparatus according to the present invention are suitable for use in minimizing power consumption particularly by narrowing power supply locations.

1. A receiving apparatus comprising:
a packet data extraction section that extracts packet data from a received signal;
an interrupt signal generation section that generates an interrupt signal for requesting reception processing of the extracted packet data;
a reception processing execution section that executes the reception processing by transitioning from a sleep mode to a running mode based on the generated interrupt signal; and
a timing control section that provides a predetermined time difference between a timing for generating the interrupt signal in the interrupt signal generation section and a timing of the transition.

2. The receiving apparatus according to claim 1, wherein:
the timing control section sets a predetermined delay time and provides the time difference such that the transition is not performed within the set delay time; and
the reception processing execution section collectively performs the reception processing requested by each of the plurality of interrupt signals generated by the interrupt signal generation section within the delay time after the transition.

3. The receiving apparatus according to claim 1, further comprising a power supply section that starts supplying power to the reception processing execution section at the timing of the transition,
wherein the timing control section provides the time difference by making a timing for starting supplying the power in the power supply section different from the timing for generating the interrupt signal in the interrupt signal generation section.

4. The receiving apparatus according to claim 1, wherein the timing control section provides an arbitrary time difference.

5. An activation control method for a receiving apparatus comprising the steps of:
extracting packet data from a received signal;
generating an interrupt signal for requesting reception processing of the extracted packet data;
executing the reception processing by, in the receiving apparatus, transitioning from a sleep mode to a running mode based on the generated interrupt signal; and
providing a predetermined time difference between a timing for generating the interrupt signal and a timing of the transition.
